(19) United States
(12) Patent Application Publication
(10) Pub. No.: US 2003/0146164 A1
(43) Pub. Date: Aug. 7, 2003

(54) ABSORPTION OF HYDROPHOBIC WATER-IMMISCIBLE LIQUIDS

(76) Inventors: DAVID J. ROBSON, DWYRAN (GB); JOHN MARK LAWTHER, BANGOR (GB); SARA A. HUGHES, BANGOR (GB)

Correspondence Address: THOMAS Q HENRY, WOODARD EMHARDT NAUGHTON MORIARTY, & MCNETT, 111 MONUMENT CIRCLE SUITE 3700, INDIANAPOLIS, IN, 46204

(21) Appl. No.: 08/876,322

(22) Filed: Jun. 16, 1997

Related U.S. Application Data
(63) Continuation of application No. 08/620,482, filed on Mar. 22, 1996, now abandoned.
(63) Continuation of application No. 08/050,060, filed on Jan. 31, 1994, now abandoned.
Application No. 08/050,060 is a 371 of international application No. PCT/GB91/01711, filed on Oct. 3, 1991.

(30) Foreign Application Priority Data
Oct. 3, 1991 (US) PCT/GB91/01711
Oct. 3, 1990 (GB) 9021509.6

(51) Int. Cl. B01D 15/04

(52) U.S. Cl. 210/693

(57) ABSTRACT

A material for absorbing hydrophobic water-immiscible liquids comprises lignocellulosic plant material which has been rendered relatively more absorbent to hydrophobic water-immiscible liquids by esterification of hydroxyl groups in the lignin of the lignocellulose material. The esterification in one aspect is by acetylation of the hydroxyl groups. Absorbing articles and methods for use with hydrophobic water-immiscible liquids are also disclosed.

The present invention relates to the absorption of hydrophobic water-immiscible liquids, particularly but not exclusively for cleaningup liquid spillages as well as to materials and products for effecting the absorption of hydrophobic water-immiscible liquids.

A wide variety of hydrophobic water-immiscible liquids absorbents have been used in the past to clean up liquid spillage in water and from around machinery (particularly to clean up oil spillage). These absorbents fall into two main categories: firstly synthetic polymers (e.g. polypropylene) and secondly natural plant based materials such as straw, peat and sawdust. However, both of these categories of materials have their disadvantages. In particular, the synthetic polymers (e.g. polypropylene) are relatively expensive in comparison with plant material whereas plant material itself has a combination of hydrophilic and hydrophobic properties and attracts both water and hydrophobic water-immiscible liquid. An additional disadvantage of these natural products is that they deteriorate during storage.

A further prior proposal made by Midland Silicones (part of DOW Corning) is the use of silanated sawdust to render the sawdust more hydrophobic and more attractive to hydrophobic water-immiscible liquids. The silanated sawdust was particularly developed to absorb oil. This proposal has the disadvantage that silanation is a relatively expensive chemical modification.

A further proposal based on the use of natural products is disclosed in EP-A-0 094 363 which describes a plant material based product specifically as an oil absorbing composition which comprises at least 50% by weight of hydrophobic cellulose pulp blended with 30%-50% of an organic cellulose paper pulp filler. The cellulose pulp is rendered hydrophobic by a conventional non-bonding hydrophobing treatment including inter alia a conventional sizing treatment. However, a disadvantage of the oil absorbing products disclosed in EP-A-0 094 363 is that they only float on water for a limited time.

It is an object of the present invention to obviate or mitigate the abovementioned disadvantages.

According to a first aspect of the present Invention there is provided, for use as an absorbent of hydrophobic water-immiscible liquids, cellulosic plant material which has been rendered relatively more attractive to hydrophobic water-immiscible liquids by chemical reaction of hydroxyl groups In the plant material

For convenience the plant material which has been rendered relatively more attractive to hydrophobic water-immiscible liquids by said chemical reaction is referred to hereinafter as the “modified plant material”. The term “plant material” as used herein covers “raw” plant material (possible formed into a product such as a paper or sheet, e.g. a TMP paper), as well as products obtained by processing of the plant material (e.g. conventionally produced papers).

According to a second aspect of the invention there is provided a method of absorbing hydrophobic water-immiscible liquids comprising treating the liquid with the modified plant material.

A third aspect of the invention provides an article for absorbing hydrophobic water-immiscible liquids comprising the modified plant material within a covering material through which liquid may pass.

A fourth aspect of the invention comprises the modified plant material in sheet form.

Examples of hydrophobic water-immiscible liquids which may be absorbed by the modified plant material are crude and refined oil, solvents such as white spirit, tolulene benzene and pesticide residues.

The preferred forms of plant material for use in the invention comprise lignocellulose, which is the collective name given to lignin, cellulose, and hemicellulose. It is however also possible to use plant material which contains neither lignin nor hemicellulose (e.g. cotton).

The preferred modification treatment for the plant material is esterification. If the plant material contains only cellulose then it is the cellulose which will be esterified. If the plant material is lignocellulose then the phenolic hydroxyl groups of the lignin and possibly also the hydroxyl groups of the cellulose and the hemicellulose are esterified. Preferably the acid residues in the ester groups are of the formula Alk-C(O)-O in which Alk is an alkyl group of 1-4 carbon atoms. Processes for esterifying cellulose and lignocellulose in the plant material are already known (see for example EP-A-0 213 252) and such prior processes are suitable for producing modified plant material for use in this invention. Typically the esterification will be effected by treating the plant material with the corresponding anhydride, removing excess anhydride, and then heating the plant material in an oven, eg in the temperature range 90-150° C. The degree of esterification should be sufficient to render the plant Material more attractive to hydrophobic water-immiscible liquids whilst still retaining internal hydrogen bonding to maintain the integrity of the material. Usually, the degree of esterification will be such as to provide a 5-40% weight gain for the plant material Preferably the weight gain is in the range 12-25%.

The preferred method of esterification is by acetylation since acetic anhydride which is of relatively low cost may be used as the acetylating agent.

Treatments other than esterification which may be used for introducing hydrophobic groups into the plant material and rendering it relatively more attractive to hydrophobic water-immiscible liquids. Such treatments include reaction with an isocyanate so as to convert the hydroxyl groups of the plant material to urethane linkages. Examples of suitable isocyanate are monoisocyanates such as propyl isocyanate, butyl isocyanate and octodecyl iscooyanate.

The agent used for rendering the plant material more attractive to water-immiscible liquids may be of di-or higher functionality so as to provide a degree of cross-linking.

The preferred plant material used as starting material for modification treatment is lignocellulose in the form of thermomechanically pulped fibre (preferably unbleached) comprising bundles of 3-5 cells so that the individual fibres have a length up to 5 mm. Other examples of plant material which may be used include chips, plant stem segments, whole plant stems. Sources of plant material for modification treatment include wood, straw, flax, linseed, bagasse, sisal, jute, kenaf, micanthus, coir, cotton and hemp.

Different plant materials do vary in their lignin content, e.g. cotton has no lignin whereas wood has approximately 30%. For the present invention it is preferred to use a plant material that has not previously been delignified for reasons of cost and enhanced reactivity.

The modified plant materials are eminently suitable for absorption of hydrophobic water-immiscible liquids. In particular, they are capable of absorbing up to 50 times their own weight of hydrophobic water-immiscible liquids from a spillage thereon in water and will retain up to 30 times their own weight when removed from water and allowed to drain. Their is the additional advantage that the modified plant material forms a discrete mass of hydrophobic water-immiscible liquid and plant material which floats on clean water whereas untreated plant material forms a mass of hydrophobic water-immiscible liquid and plant material which floats on an emulsified hydrophobic liquid/water mixture. In other words, use of untreated material causes oil to be “dragged” into the water whereas the modified material leaves the water “clean”. This has considerable implications for the dean-up of hydrophobic water-immiscible spillages in inland waterways or in areas where environmental protection is important. The chemically modified plant material ha the further advantage, over untreated fibres, in that it is less biodegradable and therefore less likely to deteriorate during storage.

The modified plant material may be presented for use in the absorption of hydrophobic water-immiscible liquids in a number of different forms. For example, the modified material may be contained within an outer “covering” through which the liquid may pass. Such a “covering” could for example be a net or porous sheet. It is therefore possible to provide the modified material in the form of a boom or pillow, i.e. a form in which oil absorbents are commonly used for cleaning oil spillages in water. To clean-up an oil-in-water spillage the boom or pillow is simply drawn through the water. Alternatively particulate or fibrous modified material may be spread on to the water surface by dropping from an aircraft. Alternatively, particulate or fibrous modified material can be blown on to the water surface.

It is also possible to provide the modified material in sheet form (eg a paper or fabric). Thus for example a sheet of lignocellulose material may be rendered attractive to hydrophobic water-immiscible liquids by any of the abovementioned treatments (eg acetylation) and used for cleaning up spillages of hydrophobic water-immiscible liquids, particularly spillages from machines or vehicles.

It should however be appreciated that the use of the modified plant material is not restricted to the clean-up of spillages. The modified material could for example be used in filters designed to separate and recover hydrophobic water-immiscible liquids from hydrophobic water-immiscible liquid and water mixtures. Alternatively, modified lignocellulose could be used to retain hydrophobic liquids on lignocellulose in moist or wet conditions, for example, for improving the retention of transformer oils on electrical papers ad increasing the intervals between oil replacement caused by moisture ingress.

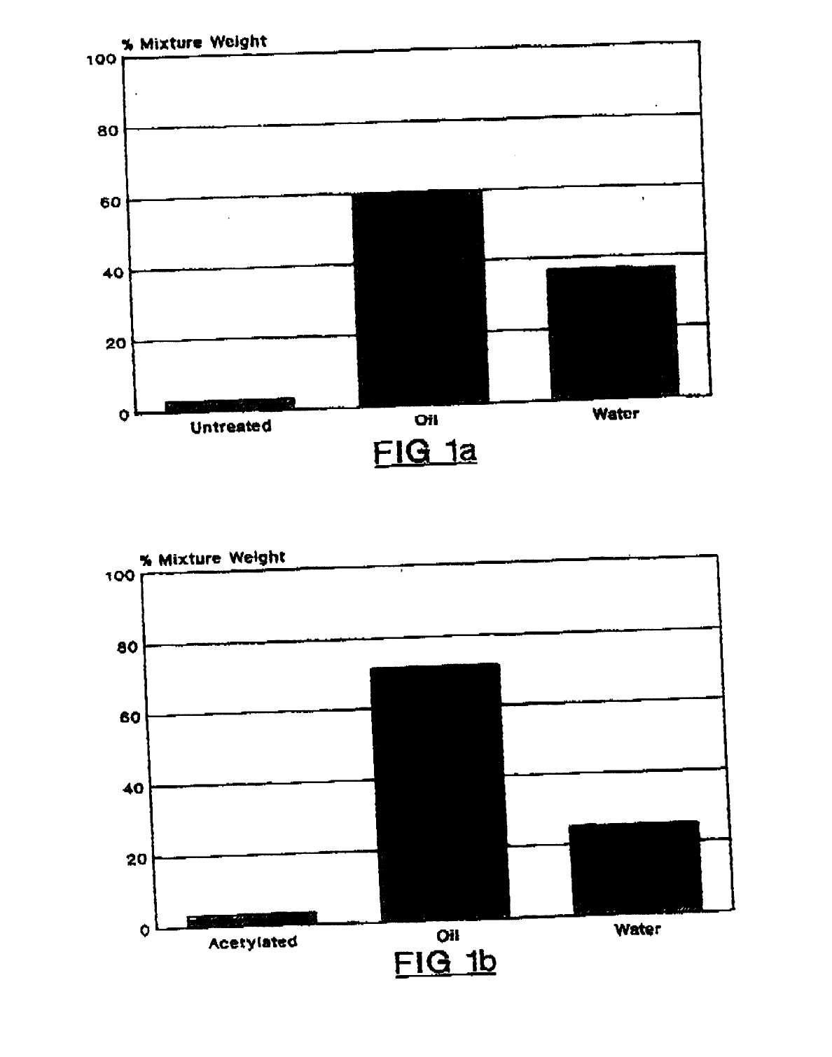

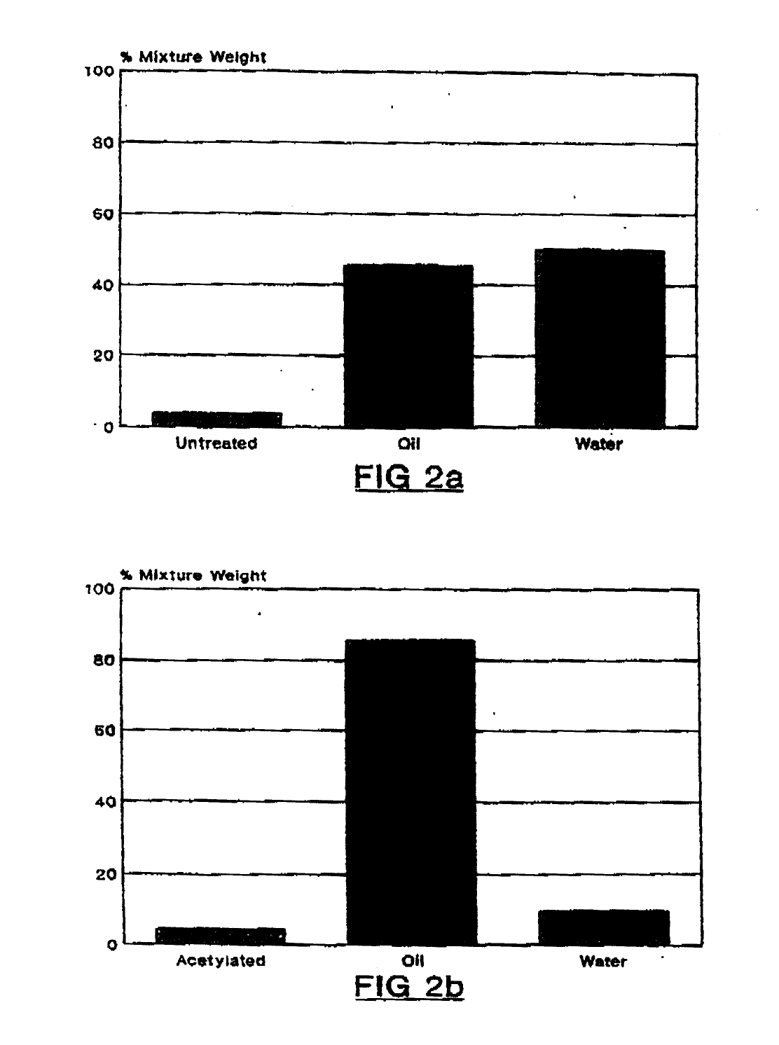

The invention is illustrated by the following non-limiting Examples together with FIGS. 1 and 2 of the accompanying drawings which are plots of data obtained in Example 2.

### EXAMPLE 1

Production of Acetylated Lignocellulose

The method used was similar to that described in Example VII of EP-A-0 2213 262. Spruce thermomechanical fibre pulp (TMP) was dipped for 1 minute in liquid acetic anhydride. Excess anhydride was squeezed out from the pulp by applying mechanical compression forces to the material yielding an acetic anhydride to fibre pulp ratio of 2.5 w/w. The impregnated pulp was then heated at 120° C. for different times. After the reaction a vacuum was applied. The fibre pulp was then air conditioned. The results are shown in Table 1.

TABLE 1

| | Raeaction Time | Weight gain due |
|---|---|---|
| Sample | at 120° C. (hours) | to acetylation (%) |
| Spruce TMP | 0.5 | 11.7 |
| | 1.0 | 22.4 |
| | 2.0 | 24.8 |
| | 4.0 | 36.5 |

### EXAMPLE 2

Removal of Oil from Sea-Water (Laboratory Test)

This Example demonstrates the removal of Medium Fuel Oil (MFO) and Transformer Oil (Class 1 uninhibited mineral insulating oil) using modified lignocellulose The modified lignocellulose used was thermomechanically pulped wood fibre acetylated in accordance with the method described in Example 1 above and with an acetyl weight gain of between 17% and 20%, and the sea-water was collected from the Irish Sea off Anglesey.

The method used was an adaptation of that described in Example 1 of EP-A-0 094 363. Briefly this adapted method was as follows: 5 gms of the modified lignocellulose fibre were mixed with 200 ml of medium fuel oil or transformer oil, and 200 ml of water. The mixture was stirred for 5 minutes using a magnetic stirrer The mixture was allowed to stand for 5 minutes then poured through a screen. The liquid-containing absorption agent collected on the screen and was allowed to drain for 5 minutes. The procedure was repeated using untreated fibres.

The liquid-containing fibre was weighed and the ratio of liquid to fibre weight calculated. The results are shown in Table 2. Additionally, the oil/water mixture recovered from he screening process was analysed to determine the relative proportions of the oil and water. From this information relative weights of the fibre, oil and water in the liquid containing fibre was calculated. The results obtained for MFO are shown in FIG. 1 and those for Transformer Oil are shown in FIG. 2.

TABLE 2

| | OIL/WATER WEIGHT GAIN BY FIBRES | |
|---|---|---|
| | (multiple of initial fibre weight) | |
| | MFO | Transformer Oil |
| ACETYLATED FIBRE | 28.1 | 20.3 |
| UNTREATED FIBRE | 30.8 | 22.4 |

As shown in Table 2 the overall weight gain by untreated and acetylated fibres was similar.

It was however found that the oil uptake of the acetylated fibres was greater than for the untreated fibre, as seen by reference to the drawings.

FIG. 1a illustrates the results obtained using untreated fibre whereas FIG. 1b shows the results for acetylated fibre. A comparison of FIGS. 1a and 1b shows that the liquid absorbed by the acetylated fibres comprised a greater percentage of MFO than the untreated fibres. More particularly, about 70% of the liquid absorbed by the treated fibre was MFO in comparison to about 60% as absorbed by the untreated fibres. It will be seen from FIG. 2 that the difference was more substantial in the case of transformer oil for which the liquid absorbed by the acetylated fibres (FIG. 2b) comprised above 80% oil in comparison with a figure of about 45% for the untreated fibres (FIG. 2a).

### EXAMPLE 3

Flotation Trails in Sea-Water.

Acetylated fibre as used in Example 2 and untreated fibre were separately floated on sea-water. Untreated fibre sank completely in sea-water after 2 days. Acetylated fibre started to sink in sea-water after 5 days. A slowly reducing proportion of the acetylated fibre continued to float for up to a month.

Acetylated fibre which had previously absorbed Medium Fuel Oil floated on sea-water for at least two months.

### EXAMPLE 4

Effect on Water Quality.

The effect of the absorption of oil by the untreated an acetylated fibres on water quality below the main fibre mass was assessed using Methods 1 and 2 below. The acetylated fibres used as in Example 2.

Method 1. Extraction and Weight Measurement.

Fibres were mixed with oil and sea water in the ratio 5 gm fibres:100 ml Medium Fuel Oil:100 ml sea-water. A water sample from below the main fibre/oil mass was taken in a 100 ml syringe The oil was extracted from the sea-water by mixing with 100 ml of chloroform. Sea-water was used as a consul. The chloroform was separated from the water and samples of the chloroform evaporated. The weight of the remaining residue, expressed as a percentage of the chloroform sample, was:

| | |
|---|---|
| untreated fibre | 0.098% |
| acetylated fibre | 0.006% |
| sea-water control | 0.010% |

Approximately 1.5% of the 100 ml of Medium Fuel Oil stirred into the untreated fibre/oil/seawater mixture is emulsified by the untreated fibres. A significantly lower amount was emulsified by the acetylated fibres.

Method 2. Extraction and UV Absorption.

UV peak absorbance of the chloroform extract obtained in Method 1 was 100 times greater for the extract from the untreated fibre mixture than for the extract from the acetylated fibre mixture. Water recovered from screening 200 ml Transformer Oil, 200 ml water and 5 gm fibre showed a UV peak absorbance over 25 times greater from the untreated fibre mixture than from the acetylated fibre

### EXAMPLE 5

Removal of White Spirit from Deionised Water.

The method was adapted from Example 1 of EP-A-0 094 363. Briefly this adapted method was as follows: 5 gm of acetylated fibre (acetyl weight gain 14-17%) were mixed with 200 ml of white spirit and 200 ml of deionised water. The mixture was for 5 minutes using a rotary stirrer. The mixture was allowed to stand for 5 minutes and then poured through a screen The liquid containing absorption agent collected on the screen was allowed to drain for 5 minutes. The liquid containing fibre was weighed and the ratio of liquid to fibre weight calculated, and the results are shown in Table 3.

TABLE 3

| | WHITE SPIRIT/WATER |
|---|---|
| | WEIGHT GAIN BY FIBRES |
| | (multiple of initial |
| | fibre weight) |
| ACETYLATED FIBRE | 15.7 |
| UNTREATED FIBRE | 17.9 |

The remaining white spirit and water which had not been absorbed by the fibre was collected, separated and the water and white spirit fractions weighed. From the weights of these fractions the uptake of the water by the fibre and the uptake of white spirit by the fibre were calculated. These values (expressed as A percentage of the total uptake) arm shown below in Table 4.

TABLE 4

| | WATER | WHITE |
|---|---|---|
| | UPTAKE | SPIRIT UPTAKE |
| | (%) | (%) |
| ACETYLATED FIBRE | 19 | 81 |
| UNTREATED FIBRE | 63 | 37 |

1. A method of absorbing hydrophobic water-immiscible liquids comprising treating the liquid with cellulosic plant material which has been modified to render it relatively more absorbent to hydrophobic water-immiscible liquids by chemical reaction of hydroxyl groups in the lignocellulose material.

2. A method as claimed in claim 1 wherein the modification is esterification.

3. A method as claimed in claim 2 wherein the esterified material has a weight gain of 5-40% as compared to the unesterified material.

4. A method as claimed in claim 3 wherein the weight gain is 12 to 25%.

5. A method as claimed in any one of claims 2 to 4 wherein the acid residues in the esterified material are of the formula Alk-C(O)-O in which Alk is an alkyl group of 1 to 4 carbon atoms.

6. A method as claimed in claim 5 wherein the esterification is acetylation.

7. A method as claimed in any one of claims 1 to 6 wherein the plant material comprises lignocellulose.

8. A method as claimed in claim 7 wherein the lignocellulose is thermomechanically pulped fibre.

9. A method as claimed in claim 8 wherein the lignocellulose comprises plant material chips, plant stem segments and/or whole plant stems.

10. A method as claimed in any one of claims 1 to 6 wherein the source of the lignocellulose is selected from wood, straw, flax, linseed, bagasse, sisal, jute, kenaf, miscanthus, coir, cotton and hemp.

11. A method as claimed in any one of claims 1 to 10 wherein the water-immiscible liquid is an oil.

12. A method as claimed in claim 11 wherein the oil is an oil spillage in water.

13. A method as claimed in claim 12 wherein the modified plant material is spread on to the surface of the water.

14. A method as claimed in claim 12 which comprises drawing through the oil an article which comprises the modified plant material within an outer covering through which the oil may pass.

15. A method as claimed in any one of claims 1 to 10 wherein the water-immiscible liquid is an organic solvent or a pesticide residue.

16. A method as claimed in any one of claims 1 to 10 for the filtration or removal of a hydrophobic water-immiscible liquid from a mixture of such a liquid with water.

17. A method claimed in any one of claims 1 to 10 for the retention of transformer oil on a paper.

18. A method of absorbing hydrophobic water-immiscible liquids comprising treating the liquid with lignocellulose material which has been modified to render it relatively more absorbent to hydrophobic water-immiscible by chemical reaction of hydroxyl groups in the lignocellulose material.

19. The use as an absorbent of hydrophobic water-immiscible liquids of cellulosic plant material which has been rendered relatively more absorbent to hydrophobic water-immiscible liquids by chemical reaction of hydroxyl groups in the lignocellulose material.

20. An article for absorbing hydrophobic water-immiscible liquid comprising cellulosic plant material which has been rendered relatively more attractive to hydrophobic water-immiscible liquids by chemical reaction of hydroxyl groups in the plant material, and a covering material through which the hydrophobic liquid may pass provided around the modified plant material.

21. An article as claimed in claim 20 in the form of a boom or pillow.

22. A sheet of cellulosic plant material which has been rendered relatively more attractive to hydrophobic water-immiscible liquids by chemical reaction of hydroxyl groups in the plant material.

23. An article as claimed in claim 20 or 21 or a sheet as claimed in claim 22 wherein the plant material comprises lignocellulose.

24. An article or sheet as claimed in claim 23 comprising acetylated lignocellulose.
